(19) United States
(12) Patent Application Publication
(10) Pub. No.: US 2019/0106863 A1
(43) Pub. Date: Apr. 11, 2019

(54) RAIN GATHERING AND STORING SYSTEM

(71) Applicant: Graham Alexander Joseph Toews, Nelson (CA)

(72) Inventor: Graham Alexander Joseph Toews, Nelson (CA)

(21) Appl. No.: 15/729,619

(22) Filed: Oct. 10, 2017

(51) Int. Cl. E03B 3/03; A01G 27/00; G09B 19/00

(52) U.S. Cl. CPC E03B 3/03; E04D 13/08; G09B 19/00; A01G 27/00

(57) ABSTRACT

A rain gathering and storing system includes a housing having a top-portion, a bottom-portion, an inner volume, a first-drain, and a second-drain, and a water proof liner configured to contain water within the inner volume of the housing. The bottom-portion may be sloped to direct the water to the second-drain. The water proof liner is able to be built-in to a form of the housing of the rain gathering and storing system which is configured for use in collecting the water. The water proof liner may be used for multiple applications with adaptable installation.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of fluid receptacles and more specifically relates to a water storage receptacle.

### 2. Description of Related Art

An important element in any water collection system is the fluid tank used to store the collected water for later use. Conventional fluid tanks may be bulky, heavy, and cumbersome to handle. Additionally, fluid tanks may have fixed volumes, which may cause users to replace fluid tanks depending on changing needs. Finally, fluid tanks may not be aesthetically pleasing, increasing the difficulty of incorporating fluid tanks positioned within outdoor landscapes. Among the more commonly cited shortcomings of such units are that their large size wastes useful living space and that they disrupt the aesthetic harmony of their immediate surroundings. A suitable solution is desired.

U.S. Pub. No. 2010/0212755 to Scott A. Gear relates to water collection and dispersion system and functional landscape architecture. The described water collection and dispersion system and functional landscape architecture includes a water collection and dispersion system having one or a series of units including structures that can be assembled for holding a leak proof liner. The liner collects water, such as, rainwater from a downspout or grey water from a building. The units can be constructed to resemble outdoor furniture such as patio walls, seating, tables, and the like. The units can also be constructed to function as framework for structures such as garden sheds, garages, pergolas, and the like.

### BRIEF SUMMARY OF THE INVENTION

In view of the foregoing disadvantages inherent in the known fluid receptacles art, the present disclosure provides a novel rain gathering and storing system. The general purpose of the present disclosure, which will be described subsequently in greater detail, is to provide an adaptable installation for multiple applications.

A rain gathering and storing system is disclosed herein. The rain gathering and storing system includes a housing having a top-portion, a bottom-portion, an inner volume, a first-drain, and a second-drain, and a water proof liner configured to contain water within the inner volume of the housing. The first-drain is proximate to the top-portion and the second-drain is proximate to the bottom-portion. In a preferred embodiment, bottom-portion may be sloped to direct the water to the second-drain. The water proof liner is able to be built-in to a form of the housing of the rain gathering and storing system which is configured for use in collecting the water. The water proof liner may be used for multiple applications with adaptable installation.

According to another embodiment, a method for collecting rain water is also disclosed herein. The method for collecting rain water includes providing a water proof liner, installing the water proof liner within a housing, collecting the rain water, and storing the rain water for use.

A kit is also disclosed herein including a set of instructions and a water proof liner to be applied to a housing per user preference.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a rain gathering and storing system, constructed and operative according to the teachings of the present disclosure.

FIG. 1 is a perspective view of the rain gathering and storing system during an ‘in-use’ condition, according to an embodiment of the disclosure.

FIG. 2 is a perspective view of the rain gathering and storing system of FIG. 1, according to an embodiment of the present disclosure.

FIG. 3 is a perspective view of the rain gathering and storing system of FIG. 1, according to an embodiment of the present disclosure.

FIG. 4 is a perspective view of the rain gathering and storing system of FIG. 1, according to an embodiment of the present disclosure.

FIG. 5 is a flow diagram illustrating a method of use for rain gathering and storing system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to fluid receptacles and more particularly to a rain gathering and storing system as used to improve the efficiency of water storage receptacles.

Generally, the present invention is a plastic or rubberized fabric tank liner that may be built in to planters, railings or standalone. A drain on bottom will allow a garden hose to be hooked up for watering. The adaptable design is adaptable to fit any house or garden while being a feature not an eye sore. The device may be made in varying sizes to fit all applications to collect rain water from down spout and store it until needed. The device may be built into planters, railings, gardens, under decks or under deck bench seats providing efficient use of space in a yard while remaining functional; the present invention provides functional aesthetics.

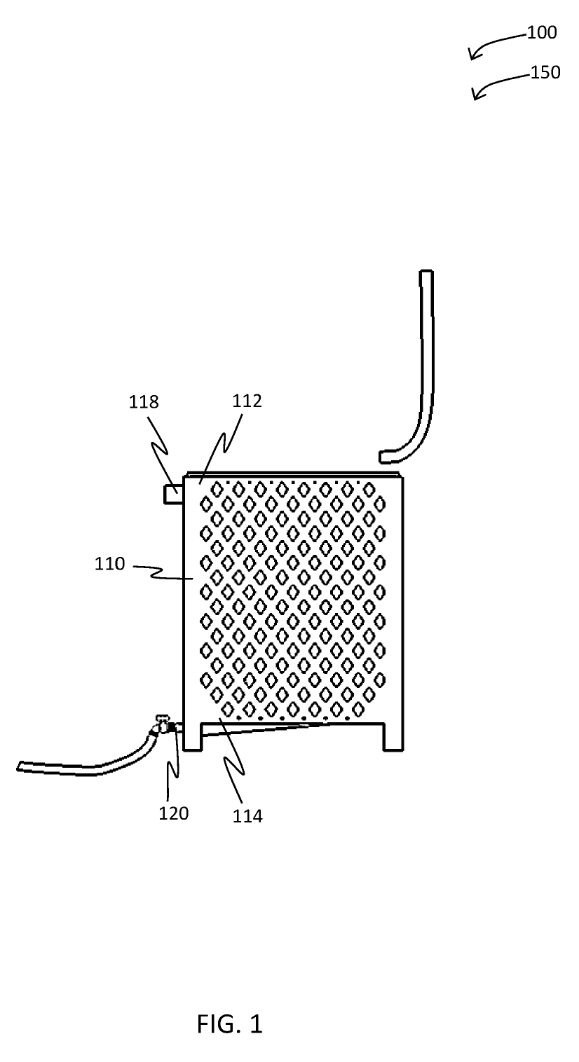

Referring now more specifically to the drawings by numerals of reference, there is shown in FIGS. 1-5, various views of a rain gathering and storing system 100. FIG. 1 shows a rain gathering and storing system 100 during an ‘in-use’ condition 150, according to an embodiment of the present disclosure. As illustrated, the rain gathering and storing system 100 may include a housing 110 having a top-portion 112, a bottom-portion 114, an inner volume 116, a first-drain 118, and a second-drain 120, and a water proof liner 130 configured to contain water within the inner volume 116 of the housing 110. The first-drain 118 is proximate to the top-portion 112 and the second-drain 120 is proximate to the bottom-portion 114. In a preferred embodiment, bottom-portion 114 may be sloped to direct the water to the second-drain 120. The water proof liner 130 is able to be built-in to a form of the housing 110 of the rain gathering and storing system 100 which is configured for use in collecting the water. The water proof liner 130 may be used for multiple applications with adaptable installation.

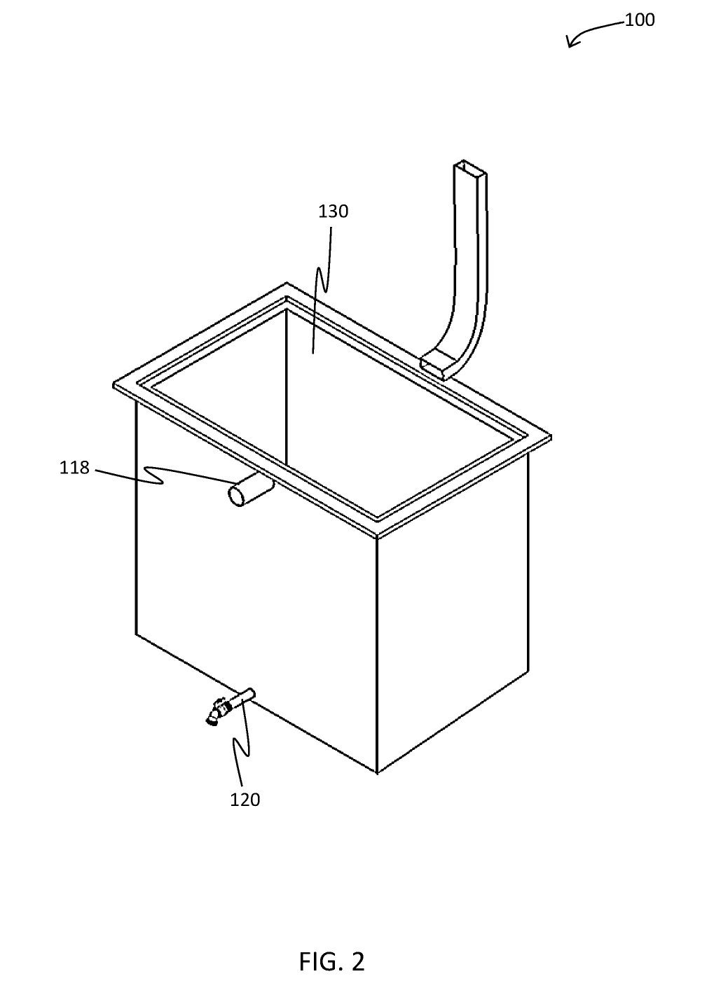

FIG. 2 shows a perspective view of the rain gathering and storing system 100 of FIG. 1, according to an embodiment of the present disclosure. As above, the rain gathering and storing system 100 may include the housing 110 and the water proof liner 130 in functional combination. The housing 110 having the top-portion 112, the bottom-portion 114, the inner volume 116, the first-drain 118, and the second-drain 120, and the water proof liner 130. In certain embodiment, the housing 110 may further include a lid or a screen for covering the top-portion 112 and the contents therein. The lid or screen may include a down-spout aperture for receiving the water into the water proof liner 130. The second-drain 120 located proximate to the bottom-portion 114 of the housing 110 may comprise a shut off valve. The second-drain 120 may also include a threaded connector allowing a user to secure to a garden hose for use of the water contained within the inner volume 116.

The housing 110 may include a rigid, generally three-dimensional rectangular profile. The housing 110 is built around the water proof liner 130. The housing 110 may be elevated off a planar surface via a plurality of legs. The rain gathering and storing system 100 further comprises an overflow point located at the top-portion 112 of the device. The first-drain 118 is configured to drain water and prevent overflow when the water contained within the water proof liner 130 reaches the overflow point.

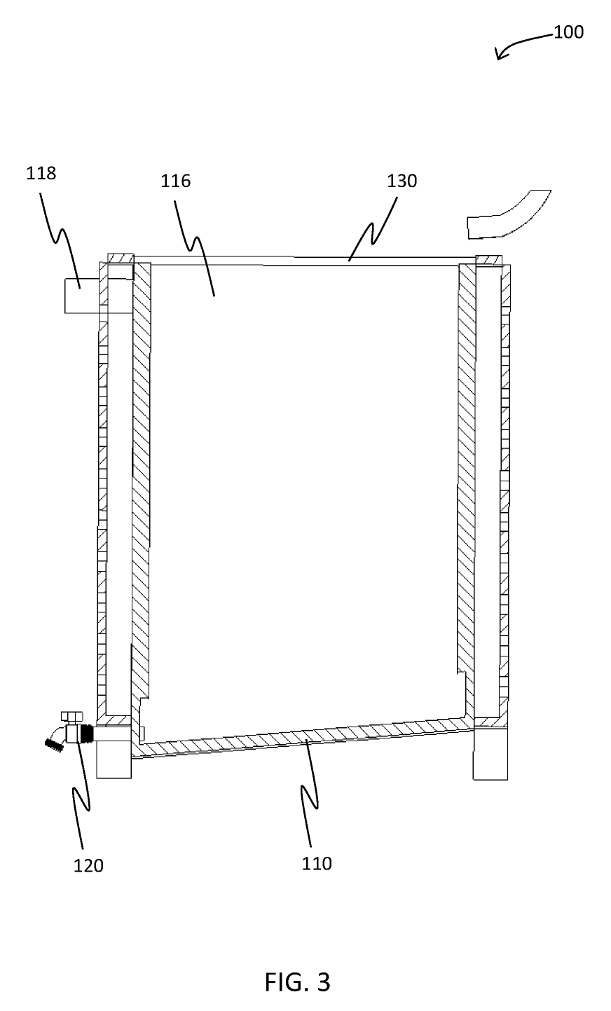

FIG. 3 shows a perspective view of the rain gathering and storing system 100 of FIG. 1, according to an embodiment of the present disclosure. As above, the rain gathering and storing system 100 may include the housing 110 having the top-portion 112, the bottom-portion 114, the inner volume 116, the first-drain 118, and the second-drain 120, and the water proof liner 130. The water proof liner 130 may include plastic, rubberized fabric, or other material which may be built in to planters, railings, or stand alone. The water proof liner 130 may be form-fitted within the housing 110. The housing 110 may include patio-accessories or other outdoor items such as planters for concealing the waterproof liner 130 in an aesthetically pleasing manner The housing 110 includes a built-in water proof liner 130.

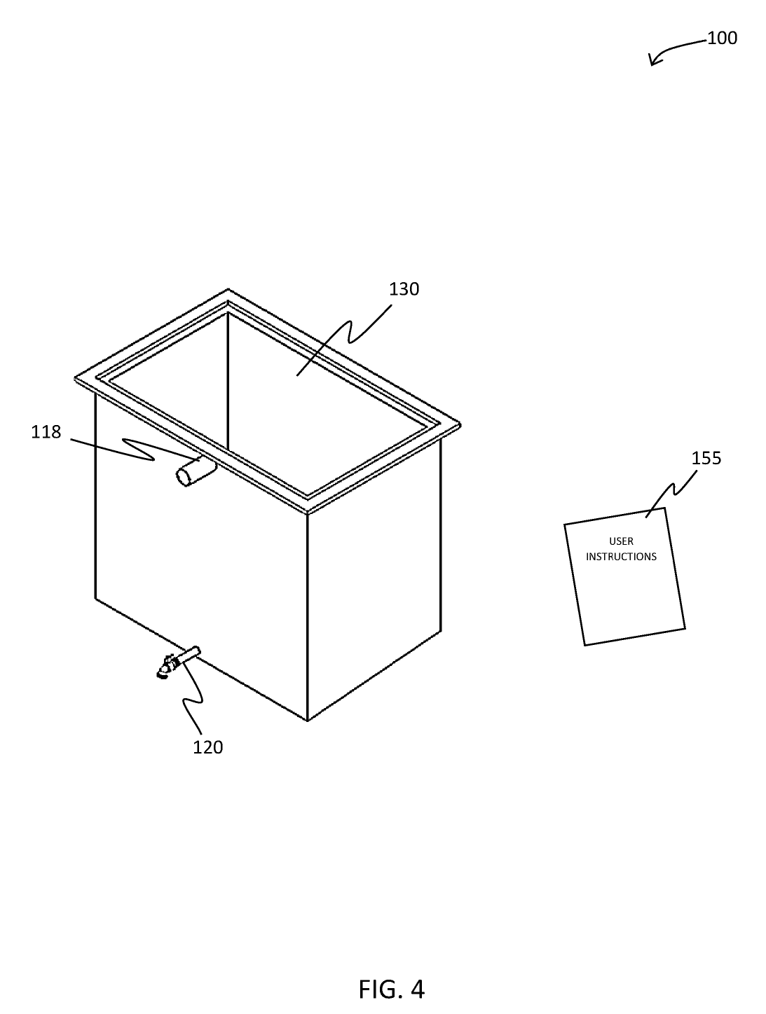

FIG. 4 shows a perspective view of the rain gathering and storing system 100 of FIG. 1, according to an embodiment of the present disclosure. According to one embodiment, the rain gathering and storing system 100 may be arranged as a kit. The kit may include a set of instructions 155 and a water proof liner 130 to be applied to a housing 110 per user preference. The instructions may detail functional relationships in relation to the structure of the rain gathering and storing system 100 (such that the rain gathering and storing system 100 can be used, maintained, or the like, in a preferred manner).

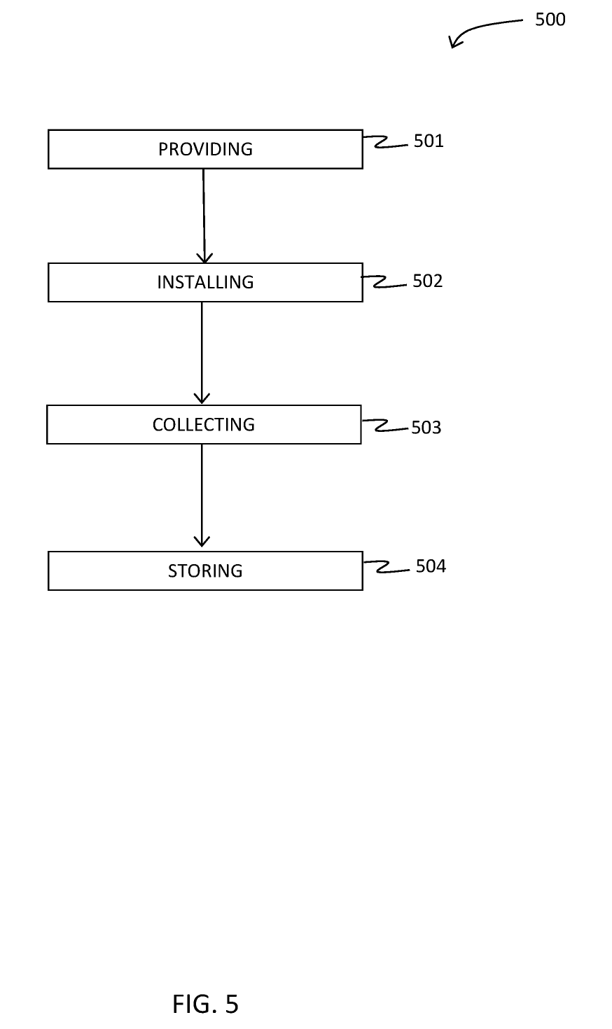

FIG. 5 is a flow diagram illustrating a method for collecting rain water 500 according to an embodiment of the present disclosure. In particular, the method for collecting rain water 500 may include one or more components or features of the rain gathering and storing system 100 as described above. As illustrated, the method for collecting rain water 500 may include the steps of: step one 501, providing a water proof liner 130; step two 502, installing the water proof liner 130 within a housing 110; step three 503, collecting the rain water; and step four 504, storing the rain water for use.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for collecting rain water [NOTE: e.g., different step orders within above-mentioned list, elimination or addition of certain steps, including or excluding certain maintenance steps, etc.], are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A rain gathering and storing system comprising:
a housing having;
a top-portion;
a bottom-portion;
an inner volume;
a first-drain; and
a second-drain;
a water proof liner configured to contain water within said inner volume of said housing;
wherein said first-drain is proximate to said top-portion and said second-drain is proximate to said bottom-portion;
wherein said bottom-portion is sloped to direct said water to said second-drain; and
wherein said water proof liner is able to be built-in to a form of said housing of said rain gathering and storing system which is configured for use in collecting said water.

2. The rain gathering and storing system of claim 1, wherein said housing further comprises a lid.

3. The rain gathering and storing system of claim 1, wherein said housing further comprises a screen.

4. The rain gathering and storing system of claim 1, wherein said second-drain comprises a shut off valve.

5. The rain gathering and storing system of claim 4, wherein said second-drain comprises a threaded connector.

6. The rain gathering and storing system of claim 5, wherein said threaded connector is configured to secure to a garden hose for use of said water contained within said inner volume.

7. The rain gathering and storing system of claim 1, wherein said housing is rigid.

8. The rain gathering and storing system of claim 7, wherein said housing comprises a generally three-dimensional rectangular profile.

9. The rain gathering and storing system of claim 1, wherein said housing is built around said water proof liner.

10. The rain gathering and storing system of claim 1, wherein said housing is elevated off a planar surface via a plurality of legs.

11. The rain gathering and storing system of claim 1, further comprises an overflow point.

12. The rain gathering and storing system of claim 11, wherein said first-drain is configured to drain water and prevent overflow when said water contained within said liner reaches said overflow point.

13. The rain gathering and storing system of claim 1, wherein said water proof liner comprises material selected from a group consisting of plastic and rubberized fabric.

14. The rain gathering and storing system of claim 2, wherein said housing comprises an opening configured such that said lid comprises a down-spout aperture for receiving said water into said water proof liner.

15. The rain gathering and storing system of claim 1, wherein said water proof liner is form-fitted within said housing.

16. The rain gathering and storing system of claim 1, wherein said housing comprises a patio-accessory with a built in said water proof liner.

17. The rain gathering and storing system of claim 1, wherein said patio-accessory comprises a planter.

18. A rain gathering and storing system, the rain gathering and storing system comprising:
a housing having;
a top-portion;
a bottom-portion;
an inner volume;
a first-drain; and
a second-drain;
a water proof liner configured to contain water within said inner volume of said housing;
wherein said housing is rigid;
wherein said housing comprises a generally three-dimensional rectangular profile;
wherein said housing is built around said water proof liner;
wherein said water proof liner is form-fitted within said housing;
wherein said housing is elevated off a planar surface via a plurality of legs;
wherein said housing comprises an opening configured such that said lid comprises a down-spout aperture for receiving said water into said water proof liner;
wherein said first-drain is proximate to said top-portion and said second-drain is proximate to said bottom-portion;
wherein said rain gathering and storing system further comprises an overflow point;
wherein said first-drain is configured to drain water and prevent overflow when said water contained within said liner reaches said overflow point;
wherein said bottom-portion is sloped to direct said water to said second-drain;
wherein said second-drain comprises a shut off valve;
wherein said second-drain comprises a threaded connector;
wherein said threaded connector is configured to secure to a garden hose for use of said water contained within said inner volume; and
wherein said water proof liner is able to be built-in to a form of said housing of said rain gathering and storing system which is configured for use in collecting said water.

19. The rain gathering and storing system of claim 18, further comprising a set of instructions; a liner; and wherein the rain gathering and storing system is arranged as a kit.

20. A method of collecting rain water using a rain gathering and storing system, the method comprising the steps of:
providing a water proof liner;
installing said water proof liner within a functionally aesthetic housing;
collecting said rain water; and
storing said rain water for use.
